(19) United States
(12) Patent Application Publication
(10) Pub. No.: US 2018/0361343 A1
(43) Pub. Date: Dec. 20, 2018

(54) Method and System for Monitoring a Chemical Reaction

(71) Applicant: Fluitec Invest AG, Hettlingen (CH)

(72) Inventors: Adrian Eiholzer, Pfaeffikon (CH); Daniel Altenburger, Oerlingen (CH); Esteban Rosasco, Elgg (CH); Norbert Merkel, Engen (DE); Marlies Moser, Andelfingen (CH); Alain Georg, Hettlingen (CH)

(21) Appl. No.: 16/012,365

(22) Filed: Jun. 19, 2018

(30) Foreign Application Priority Data
Jun. 20, 2017 (EP) 17 176 808.8

(51) Int. Cl. B01J 19/00; B01J 19/18; B01J 19/24

(52) U.S. Cl. CPC B01J 19/002; B01J 19/1818; B01J 19/242; B01J 2219/182; B01J 2219/185; B01J 2219/1943; B01J 2219/0027; B01J 2219/00164; B01J 2219/002; B01J 2219/00213; B01J 2219/00225; B01J 2219/00234; B01J 2219/00259; B01J 2219/00033

(57) ABSTRACT

In a method for monitoring a chemical reaction in a continuously operated reactor with at least one tube section, wherein the reactor has an intake, an outlet and a main flow direction running between the intake and the outlet, substances are supplied to the reactor via the intake and a product mixture made up of these substances and the solidified products thereof is created in the reactor. The reaction is monitored and measures are taken to prevent an uncontrolled reaction process, wherein these measures comprise at least the following steps: interruption of the intake and outlet, active pressure relief of the reactor and flushing of the reactor with an inert substance. This facilitates a safe and efficient interruption of the chemical reaction.

### CROSS-REFERENCE TO RELATED APPLICATION

This application claims priority to European Patent Application No. 17 176 808.8 filed Jun. 20, 2017, the disclosure of which is hereby incorporated in its entirety by reference.

### BACKGROUND OF THE INVENTION

### Field of the Invention

The present invention relates to a method for monitoring a chemical reaction in a continuously operated reactor and also a system for implementing the method.

### Description of Related Art

The safety of a production process plays an important part in the chemical industry. It is therefore customary for chemical production processes to be constantly monitored, in order to avoid possible hazardous states which could lead to explosions or to a release of chemicals, for example.

Many chemical reactions are exothermic and are therefore associated with the release of heat. If the quantity of heat released per unit of time cannot be adequately removed, the reaction mass itself heats up. As a result of this, the reaction speed increases and the reaction is accelerated. If this situation can no longer be controlled, the aforementioned thermal explosion takes place which is usually associated with a high pressure build-up due to the incipient evaporation and gas development. This is also referred to as a reaction runaway.

It is known in the art that continuously operated tube reactors are substantially safer than methods involving large stirrer tanks, such as a CSTR (continuously stirred reactor) for example. On the one hand, this is due to the smaller volumes involved; on the other hand, the tube reactor has a better surface/volume ratio which means that the heat can be removed more effectively in tube reactors.

The question that arises is whether a reaction can be carried out at a generally higher temperature level in continuously operated chemical reactors than in stirrer tanks and whether the limit temperature Tₑₓₒ can be set at a correspondingly higher level.

The safety principle of the German Commission on Process Safety TRAS410 from 2012 states that the limit temperature (Tₑₓₒ) refers to the maximum permitted temperature at which a substance or a reaction mixture can still be handled in a risk-free manner. It is specified taking account of the method parameters and the measurement methods that have been used when determining the characterizing substance variables. Hence, for example, in the case of a continuous method in which the substances have been thermally loaded only for a comparatively short time, a higher limit temperature must be set than in a batch method in which the substances can be exposed to higher temperatures over a prolonged period.

This principle therefore clearly indicates that in the case of continuous methods, these can be carried out with higher temperature differences than the customary 50° C. Unfortunately, however, no permitted maximum temperature differences for continuous processes in tube reactors are specified.

It is customary for controls to be provided for the operation, monitoring and safety of a plant or system.

PLT (process control engineering) operating and monitoring devices with corresponding process control engineering controls are known in the art. For exothermic reactions, they are substantially made up of two elements:
monitoring of the reaction runaway by means of an alarm when a given maximum value of the internal reactor temperature is exceeded,
monitoring/alarm in the case of reactant accumulation.

A reactant accumulation in the reactor is associated, on the one hand, with the risk of the reaction dropping off; on the other hand, there is a risk of the reaction migrating. An incalculable safety risk exists in that the reaction mixture that has not reacted can run away downstream of the reactor, for example in the collecting container or in another piece of apparatus. Reliable reaction monitoring therefore requires the reaction enthalpy due to accumulated reactants in the reactor which has not yet been released to be accurately identified at each point in time.

In the as yet unpublished patent application EP 15 200 463.6 dated 16 Dec. 2015 entitled “Method for monitoring a chemical reaction and reactor”, an in-line method for tube reactors is described which allows extensive monitoring of a continuous chemical process in tube reactors. An accumulation or migration of the chemical reaction is recognized at an early stage and quickly.

### SUMMARY OF THE INVENTION

A problem addressed by the invention is therefore that of providing an efficient and safe measure for preventing an uncontrolled reaction in a continuously operated reactor, in particular a tube reactor; this applies in particular when an accumulation or migration of the reaction is identified. This problem is solved by a method for monitoring a chemical reaction in a continuously operated reactor having the features of Patent claim 1 and also a system for carrying out the method having the features of Patent claim 12.

The method according to the invention is used to monitor a chemical, in particular exothermic, reaction in a continuously operated reactor with at least one tube section, wherein the reactor has an intake, an outlet and a main flow direction running between the intake and the outlet. According to the invention, substances are supplied to the reactor via the intake and a product mixture made up of these substances and the solidified products thereof is created in the reactor, wherein the reaction is monitored and measures are taken to prevent an uncontrolled reaction process. These measures comprise at least the following steps:
interruption of the intake and outlet,
active pressure relief of the reactor and
flushing of the reactor with an inert substance.

The reactor is preferably a tube reactor, preferably an empty tube or a tube with at least one fitting or multiple fittings. The fittings are, for example, mixer-heat exchangers, filling materials, packing materials or static mixers. The reactor is continuously operated and is not therefore a stirred-tank reactor, in particular it is not a stirrer unit and not a CSTR.

The main flow direction of a reactor is the straight-line connection of the input and output of the reactor or in case there are a multiple of reactor segments connected y lines with each other, the main flow direction is the straight line connection between the input and output of the corresponding reactor segments. This main flow direction usually corresponds to the direction of the longitudinal extent of the reactor.

Monitoring of the reaction preferably takes place as in the previously mentioned EP 15 200 463.6, in particular by means of a thermal balance detection and local temperature measurement. This means that an accumulation and/or migration of the reaction can be reliably detected. Depending on the embodiment, in addition or alternatively, probes are preferably present for measuring substance properties (for example refraction index probes, pH probes, infrared, NIR, Raman and ATR probes) which identify migration at the reactor outlet. Other kinds of reaction monitoring can likewise be used in the method according to the invention.

This method according to the invention allows a production process to be interrupted quickly and safely, so that the reason for the accumulation or migration of the reaction can then be investigated. In addition, the method according to the invention prevents a local runaway of the reaction, so that there can be no chain reaction in the system, e.g. in a dwell time reactor that may be downstream or in a storage container that may be present.

Thanks to the interruption of the intake and outlet, a complete compartmentalization of the reactor volume is achieved. Shut-off fittings such as ball cocks, needle valves, shut-off valves or the like, are suitable as shut-off means. They are preferably redundant in design and/or they are cooled. The redundant design guarantees a complete compartmentalization. The cooling prevents a runaway in the tubing.

Thanks to the method according to the invention, reactions with higher permitted temperature differences can be carried out. The advantages of these higher temperature differences are:
The reactions take place more quickly and therefore shorter dwell times are needed. This leads straight to lower investment costs.
The use of solvents can be reduced or even dispensed with entirely. This means that additional energy-intensive separating methods can be dispensed with or at least substantial energy savings can be made.

In preferred variants of the method, direct pressure relief and flushing only take place following interruption of the intake and outlet.

The pressure relief of the reactor preferably takes place following the compartmentalization of the reactor volume, but even more preferably directly thereafter. Active pressure relief preferably takes place immediately after malfunctions have been identified, preferably by means of opening shut-off devices.

Active pressure relief and flushing with the inert substance preferably take place simultaneously.

Passive pressure relief can be guaranteed by a safety valve. However, this is preferably not used and is only present as a redundant safety element.

Flushing preferably takes place against the main flow direction of the reactor, i.e. backwards to the reactor inlet. In this case, a first fraction of the product mixture, namely the reactive mixture with the highest adiabatic temperature increase, is initially flushed out of the reactor. A second fraction of the product mixture which is already present as the reactive product, i.e. which has already been converted partially or completely as a result of a prolonged dwell time, will leave the reactor later than the first fraction.

The reactor is preferably arranged perpendicularly, so that the main flow direction runs in a vertical direction. The flushing in this case preferably takes place from top to bottom, either in the main flow direction or preferably in the opposite direction thereto.

If the reactor is made up of a plurality of tube segments which are connected to one another by lines, these segments are preferably stacked on top of one another from the bottom upwards and connected in series, wherein the reactor inlet preferably lies at the bottom and the reactor outlet at the top.

This vertical arrangement and also the flushing in the opposite direction are particularly advantageous when a gas is used as the inert substance. The gas in this arrangement forces the reactor mixture, which is usually liquid, from the top downwards out of the reactor. This speeds up flushing. Nitrogen and argon are examples of suitable inert gases.

The use of gas as the inert substance is not only suitable with a vertical arrangement but also with a horizontal arrangement, as the constantly diminishing filling level occurring due to gas in any event reliably prevents a pressure rise if there is a runaway in the reactor. In addition, the fittings, particularly in the case of mixer-heat exchangers, prevent the gas from shooting through, so that the liquid continues to move and constant cooling is therefore guaranteed, even in a vertical system.

When a liquid is used as the inert substance, the reactor is likewise preferably arranged vertically. Flushing may take place in the main flow direction or in the opposite direction. An arrangement of the reactor in other positions, such as horizontally for example, is likewise possible and when inert liquids are used, practically equivalent to the vertical orientation. Examples of liquids are solvents such as isopropanol or water, for example.

The product mixture is preferably flushed at pressure from the reactor by means of the inert substance. This is the case particularly with the vertical arrangement and flushing in the opposite direction with an inert gas. The reaction mixture flows therethrough and constant cooling with a closed system is therefore guaranteed.

The reaction mixture flushed from the reactor is preferably flushed in a collecting tank provided with a second inert substance. The reaction mixture is preferably forced into the collecting tank.

In order to prepare the way into the collecting tank, shut-off fittings are normally active. These are controlled valves, for example, wherein other kinds of shut-off fittings can also be used. Spring-opening shut-off fittings have the advantage that they can be used even if there is a power failure in the system.

The reaction mixture is preferably distributed in the collecting tank by means of a jet pump, a nozzle, a tube hole distributor or a similar means and mixed with the second inert substance. Such a collecting tank is generally also called quench container.

The second inert substance located in the collecting tank is preferably an inert liquid. The second inert substance is customarily a solvent or a liquid without decomposition potential.

The system according to the invention for implementing the method according to the invention has a continuously operable reactor, in particular a tube reactor, having a main flow direction, with an intake for supplying substances to the reactor and an outlet for removing the product resulting from the substances through chemical reaction. The system has controls for monitoring the reaction in the reactor. In addition, it has safety means for preventing an unchecked reaction process, wherein these safety means comprise:
at least one shut-off means for shutting off the intake,
at least a second shut-off means for shutting off the outlet,
a flushing means tank and a flushing line from the flushing means tank to the reactor, wherein the first flushing line is provided with at least a third shut-off means and
a collecting tank for reaction mixture flushed out of the reactor and also a collecting line from the reactor to the collecting tank, wherein the collecting line is provided with at least a fourth shut-off means,
   wherein the aforementioned shut-off means can be opened and closed by means of the controls in accordance with the means for monitoring the reaction.

The control is preferably an electronic control and is preferably used continuously. There is preferably also a safety mechanism which has safety valves and/or blow-out discs.

A jet pump, a nozzle or a tube hole distributor is preferably arranged in the collecting tank for the static mixing of the back-flushed reactor mixture with a second inert substance found in the collecting tank.

The reactor is preferably arranged in a vertical direction and the main flow direction is upwards from below.

The flushing line preferably leads from the flushing tank to the upper end of the reactor, so that the flushing means flows through the reactor in the opposite direction to the main flow direction downwards from above.

Further embodiments are indicated in the dependent claims.

### BRIEF DESCRIPTION OF THE DRAWINGS

Preferred embodiments of the invention are described below with the help of the drawings which are only used by way of explanation and should not be interpreted as limiting. In the drawings:

FIG. 1 shows a schematic representation of a system according to the invention having three horizontal reactor segments and a flushing device;

FIG. 2 shows a schematic representation of a system according to the invention having a vertical reactor and a flushing device and

FIG. 3 shows a schematic representation of a variant of the system according to FIG. 1.

### DESCRIPTION OF THE INVENTION

Three embodiments of the system according to the invention are described below, with the help of which the method according to the invention can be understood.

The figures are purely schematic. Not shown, for example, are the means which monitor the reaction and also the electronic controls. The means and the evaluation are preferably used as described in the as yet unpublished EP 15 200 463.6.

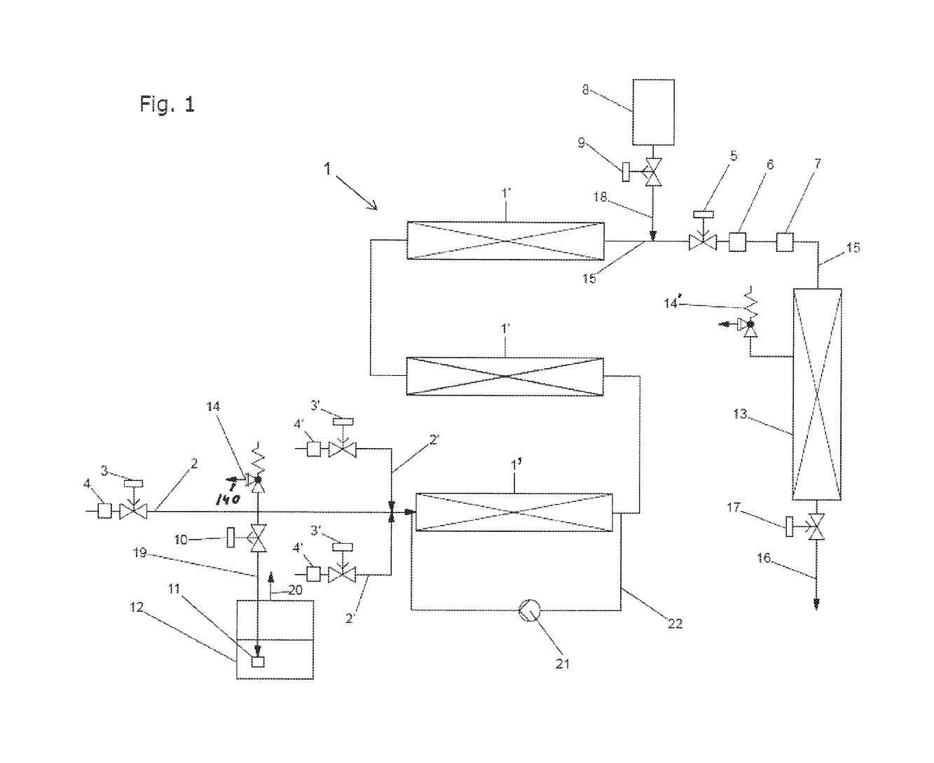

The system according to FIG. 1 has a continuously operated tube reactor 1 with at least one tube section 1′. If multiple tube sections 1′ are present, they are preferably connected in series behind one another. At least one of the tube sections, preferably all tube sections 1′, is/are preferably flowed through for the purpose of temperature regulation (i.e. heating or cooling) of a heat transfer medium. The tube sections are preferably provided with a static mixer or a mixer-heat exchanger.

At least when using the process monitoring according to EP 15 200 462, the tube sections are selected in such a manner that the temperature profile of the heat transfer medium has an approximately linear profile in each tube section.

Substances are fed to the reactor 1 via at least one supply line 2, 2′, the intake. The substances are reactants such as main components, additives, activators, solvents, emulsion additives and catalysts. They may be present in liquid, gaseous or partially solid form. In addition, the reactions may be carried out in a diluted solution or also in a dispersion.

In the supply lines 2, 2′ first flow meters 4, 4′ are present which measure the flow of supplied substances. Each supply line 2, 2′ is additionally provided with one, preferably two or more, first shut-off devices 3, 3′, also referred to as shut-off fittings. These first shut-off devices 3, 3′ are preferably arranged in the flow direction to the reactor 1 downstream of the flow meters 4, 4′. They may also, however, be arranged upstream thereof. A first safety valve 14 with an outlet line 140 is arranged in at least one of the supply lines 2, 2′. The first safety valve 14 is preferably arranged between two first shut-off devices 3, 3′, as shown in FIG. 1. In case of only one single first shut-off device 3, the safety valve 14 is preferably arranged after the first shut-off device 3.

The first shut-off devices 3, 3′ are connected to an electronic control which is not shown and are closed in accordance with this control. The shut-off devices are preferably valves, stop cocks or shut-off valves. They preferably have a spring closure.

The products of the chemical reaction taking place in the reactor 1 are removed via an outlet, more accurately a discharge line 15. In the example shown here, they reach a dwell time reactor 13 before they are moved on via an end line 16.

As a variant, a circulation line 22 can be provided in one or more of the tube or reactor sections 1′, preferably in the first tube section 1′ in the flow direction. This is depicted in FIG. 1. By means of a pump 21, the reaction mixture at the outlet of the corresponding tube section, in this case the first tube section 1′, is fed back and introduced back into the reactor in the main flow direction further upstream. In the example shown, the line once again leads to the inlet of the first reactor section 1. This method and the advantages thereof are described in detail in WO 2017/080909.

Between reactor 1 and dwell time reactor 13 there is at least one second shut-off device 5. This is also preferably redundant, so that two or more second shut-off devices 5 of this kind are arranged in the discharge line 15. The second shut-off device 5, also referred to as the shut-off fitting, is likewise connected to the controls and can be closed by means thereof. It is likewise preferably spring-closing.

A second flow meter 6 for measuring the total volume flows of the product and a probe 7 for measuring substance properties is preferably present in the discharge line 15 between the reactor 1 and the dwell time reactor 13.

The second shut-off device 5 is preferably arranged in the flow direction upstream of these devices, like the second flow meter 6 and probe 7.

The dwell time reactor 13 preferably has a second safety valve 14′. A further shut-off valve 17 is preferably arranged in the end line 16.

In addition, the system has a receiver for an inert substance, in particular an inert gas or an inert liquid. In the figures, this receiver is a flushing means tank 8. A flushing line 18 leads from the tank 8 to the outlet of the reactor 1. This flushing line 18 is closed using a third shut-off device 9 which is likewise connected to the controls and which is preferably spring-opening. The flushing line 18 preferably opens out into the discharge line 15, but upstream of the second shut-off device 5 in the flow direction of the product.

In the intake of the reactor 1, a collecting line 19 branches off which is closed using a fourth shut-off device 10. This fourth shut-off device 10 is also connected to the controls. It is spring-opening.

The third and fourth shut-off devices are preferably likewise redundant.

The collecting line 19 leads to a collecting container 12. An inert substance, preferably an inert liquid, is located in the collecting container 12. It may be the same substance as that located in the flushing means container 8 or another substance. In particular, the flushing means container 8 may be filled with an inert gas and the collecting container 12 with an inert liquid.

Means for mixing 11 are preferably available in the collecting tank 12 such as, for example, a jet pump and/or a nozzle and/or a tube hole distributor.

If data from the means for monitoring safety, which are not shown, should reveal that there is a risk of the chemical reaction in the reactor 1 following an unregulated course, the controls close the first and all second shut-off devices 3, 3′, 5 and thereby separate the reactor 1 from the intake 2, 2′ and outlet 15, in particular from the dwell time reactor 13.

The controls also open the third and fourth shut-off device 9, 10. Flushing means, i.e. the inert liquid or the inert gas, are fed under pressure into the reactor 1 and flow through said reactor in the opposite direction to the main flow direction of the reactor 1. In this case, the flushing means forces the reaction mixture out of the reactor 1 to the collecting tank 12. Here it is distributed via the mixing means 11 and mixed relatively quickly with the second inert substance already located in the collecting tank.

During this process, the reactor is also pressure-relieved or vented. This takes place through the opening of the third and fourth shut-off devices 9, 10. Any excess of inert substance can be removed via the line 20. Normally, the overflow is discharged into the atmosphere via an excess gas burner or via a scrubber. The excess may, however, also be removed for the purpose of cleaning or also for scrubbing.

The chemical reaction is thereby efficiently and reliably interrupted and damage can be avoided.

In the embodiment according to FIG. 1, the reactor 1 is depicted with three horizontal tube sections 1′. Flushing therefore takes place with the vertical tubes. This arrangement is suitable as an inert flushing means both with the use of liquids or gas.

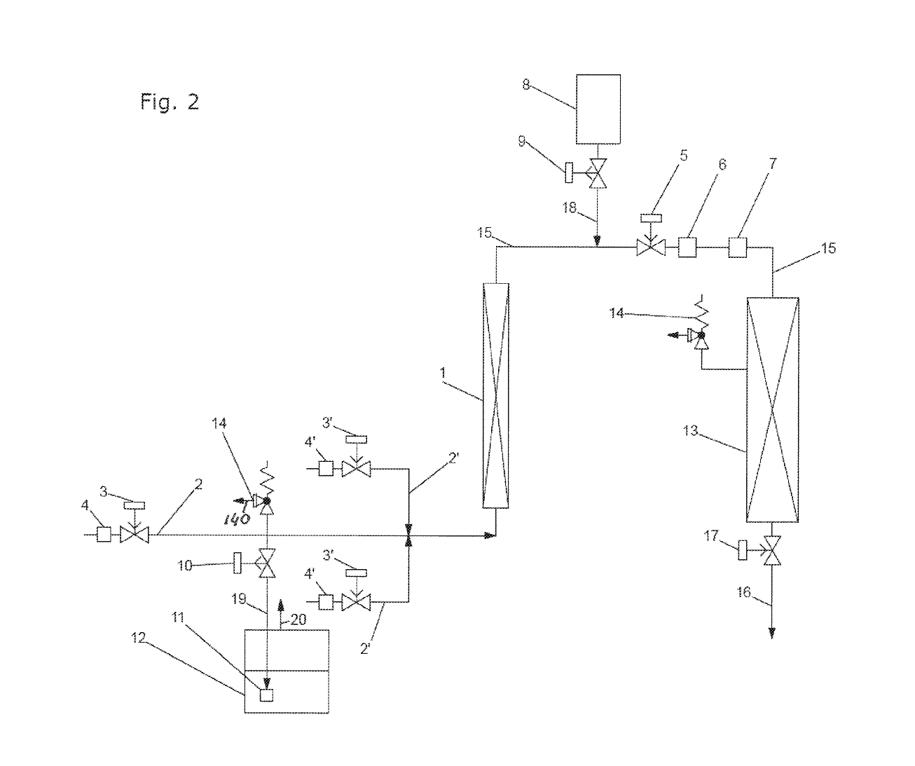

In the embodiment according to FIG. 2, the reactor 1 is vertically aligned. The intake is located at the bottom, the outlet at the top. The flushing means are introduced into the reactor 1 from the top downwards. This is particularly advantageous when a gas is used as the inert flushing means, as through this arrangement the gas forces the liquid reaction mixture downwards towards the intake and into the collecting tank 12 and the emptying of the reactor takes place even more quickly in case of an emergency. This vertical embodiment may also be formed with a plurality of series-connected tube sections 1′, wherein the tube sections in this case are preferably stacked on top of one another, so that the outlet of the lower tube section 1 in each case lies below the intake of the upper tube section 1′.

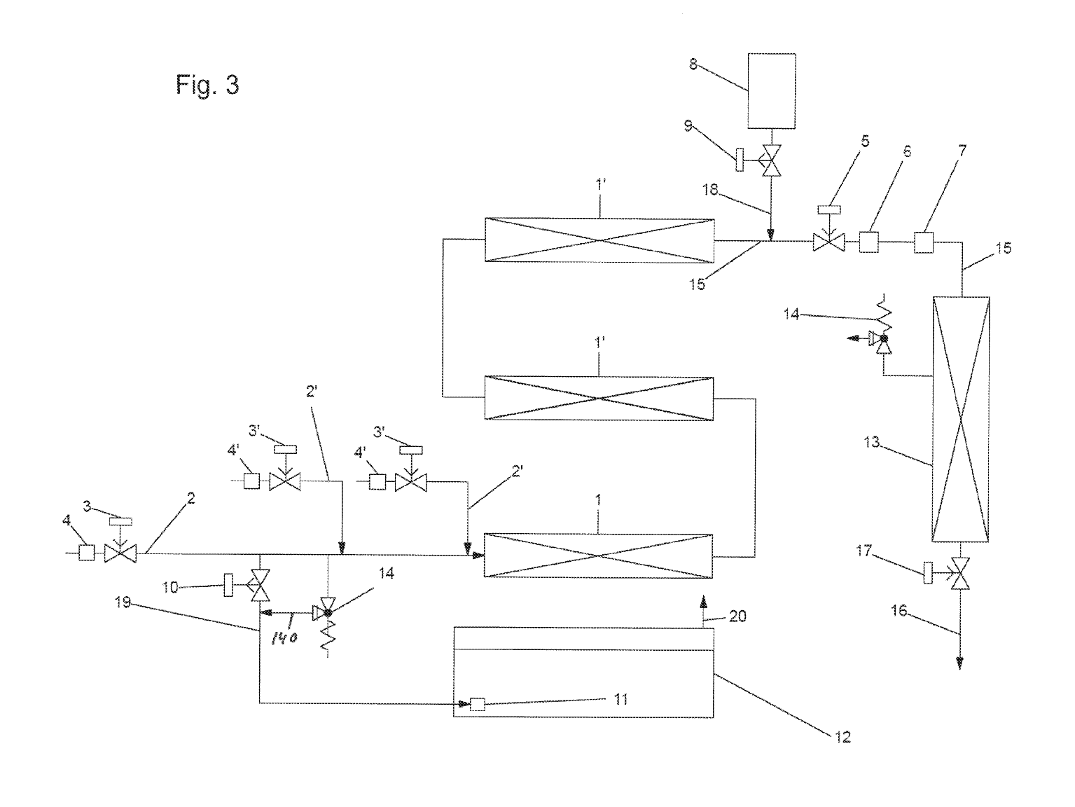

The embodiment according to FIG. 3 is a variant of the embodiment according to FIG. 1. This variant can also be used in the embodiment according to FIG. 2. It has been shown in the systems described above that very large gas volume streams can occur in a decomposition, so that the collecting line 19 as well as the outlet line 140 have to be chosen to be quite big. During the flushing procedure however the volumes are relatively small. This can be a problem, when the reacting fluid remains in the collecting line 19 and as well as in the outlet line 140 after the first safety valve 14 and when then it comes to a decomposition.

In the embodiment according to FIG. 3, the outlet line 140 of the first safety valve 14 is therefore connected to the collecting line 19. The collecting line 19 is preferably as short as possible and it has an incline. The collecting line 19 guides the reacting fluid into the collecting container 12 and dilutes it before a decomposition can take place. The collecting container 12 therefore forms a quench container. In case that it still comes to a decomposition, the decomposing gas can be discharged through the removal line 20.

The method according to the invention and the device according to the invention allow safe and efficient interruption of a chemical process in a continuously operating reactor, in particular a tube reactor.

1. A method for monitoring a chemical reaction in a continuously operated reactor with at least one tube section, wherein the reactor has an intake, an outlet and a main flow direction running between the intake and the outlet,
wherein substances are supplied to the reactor via the intake and a product mixture made up of these substances and solidified products thereof is created in the reactor,
wherein the reaction is monitored and measures are taken to prevent an uncontrolled reaction process,
wherein these measures comprise at least the following steps:
interruption of the intake and outlet,
active pressure relief of the reactor and
flushing of the reactor with an inert substance.

2. The method according to claim 1, wherein active pressure relief and flushing take place only after the intake and outlet have been interrupted.

3. The method according to claim 1, wherein active pressure relief and flushing take place simultaneously.

4. The method according to claim 1, wherein flushing takes place against the main flow direction of the reactor.

5. The method according to claim 1, wherein the main flow direction runs in a vertical direction and flushing takes place from top to bottom.

6. The method according to claim 1, wherein an inert gas is used as the inert substance for flushing.

7. The method according to claim 1, wherein an inert liquid is used as the inert substance for flushing.

8. The method according to claim 1, wherein the product mixture is flushed at pressure from the reactor by means of the inert substance.

9. The method according to claim 1, wherein the reaction mixture flushed from the reactor is flushed in a collecting tank provided with a second inert substance.

10. The method according to claim 9, wherein the reaction mixture is distributed in the collecting tank by a jet pump, a nozzle, a tube hole distributor or a similar means and mixed with the second inert substance.

11. The method according to claim 9, wherein the second inert substance is an inert liquid.

12. A system for implementing the method according to claim 1, wherein the system has a continuously operable reactor, having a main flow direction, with an intake for supplying substances to the reactor and an outlet for removing the product resulting from the substances through chemical reaction, wherein the system has controls with means for monitoring the reaction in the reactor, wherein the system has, in addition, safety means for preventing an unchecked reaction process, wherein these safety means comprise:
at least a first shut-off means for shutting off the intake,
at least a second shut-off means for shutting off the outlet,
a flushing means tank and a flushing line from the flushing means tank to the reactor, wherein the flushing line is provided with at least a third shut-off means,
a collecting tank for reaction mixture flushed out of the reactor and also a collecting line from the reactor to the collecting tank, wherein the collecting line is provided with at least a fourth shut-off means,
wherein the aforementioned shut-off means can be opened and closed by means of the controls in accordance with the means for monitoring the reaction.

13. The system according to claim 12, wherein a jet pump, a nozzle, or a tube hole distributor is arranged in the collecting tank for mixing the back-flushed reactor mixture with a second inert substance found in the collecting tank.

14. The system according to claim 12, wherein the reactor is arranged in a vertical direction and the main flow direction takes place upwards from below.

15. The system according to claim 14, wherein the flushing line leads from the flushing tank to the upper end of the reactor, so that the flushing means flows through the reactor in the opposite direction to the main flow direction downwards from above.
